(19) United States
(12) Patent Application Publication
(10) Pub. No.: US 2020/0101707 A1
(43) Pub. Date: Apr. 2, 2020

(54) LAMINATION MACHINE

(71) Applicant: Tomas Vaclavik, Frymburk (CZ)

(72) Inventor: Tomas Vaclavik, Frymburk (CZ)

(21) Appl. No.: 16/359,887

(22) Filed: Mar. 20, 2019

(30) Foreign Application Priority Data
Apr. 23, 2018 (CZ) 2018-194

(51) Int. Cl. B32B 37/00

(52) U.S. Cl. CPC B32B 37/0046; B32B 37/0007; B32B 2309/16

(57) ABSTRACT

The lamination machine with a supporting table and a sticking cylinder, which is a part of the frame bridge put on the supporting table, its sticking cylinder is at each end placed rotationally into the bearing of the bridge, which is placed in a hanger carried by at least one travel of the bridge, so it is placed movably parallelly above the working surface of the supporting table, besides the travels of the bridge ale linked by the lower crossbeam of the bridge and placed movably for movements above the supporting table in guides in two opposite sidewalls of the supporting table, where delineative bars at both sides of the supporting table guarantee a balanced lateral shift of the bridge above the supporting table and/or the sticking cylinder is at each end equipped with a pressure mechanism placed at the lower crossbeam of the bridge and with a lifting element in the placing of the hanger of the bridge.

### RELATED APPLICATIONS

This application claims priority to Czech Republic US application serial number 2018-194 filed on Apr. 23, 2018 and incorporated herewith by reference in its entirety.

### FIELD OF THE INVENTION

The invention concerns the machine for adhering either printed or non-printed self-adhesive foils to plane surfaces to be used especially in commercial agencies, production of road signs, designing studios, glass industry and furniture production.

### BACKGROUND OF THE INVENTION

The machines with a sticking cylinder used nowadays for adhering printed or non-printed self-adhesive foils to plane surfaces have a cylinder that is pressed down with arms and springs, or the cylinder is at each side positioned using a pneumatic pressure. The cylinder is usually placed into linear guides or without them, so it is impossible to retain moment forces when pressing the foil to the surface. Consequently, there is a risk of improper, inaccurate or wrinkled foil sticking.

To stick the foil correctly, it is necessary to retain the back-pressure/pre-tension of the supporting table against the cylinder; lots of manufacturers do not handle this problem at all or use a construction with two beams, one above the other one, which are pressed away. So the machine is massive, heavy and hard to control.

The bridge guided above the supporting surface with a massive beam attached to the working surface has similar drawbacks. The existing devices are equipped with fixed legs-supports, so the device handling is hard and has non-ergonomic hitches, where the cover for the lateral side of the bridge is separate and the manipulation handle is separate as well.

### SUMMARY OF THE INVENTIONS

The described drawbacks are eliminated when using the lamination machine with a supporting table and a sticking cylinder, which is a part of the frame bridge put on the supporting table; its working principle is that the sticking cylinder is at each end placed rotationally into the bridge bearing, which is placed in a hanger carried by at least one bridge travel, so it is placed movably parallelly above the working surface of the supporting table, besides the bridge travels ale linked by the lower bridge crossbeam and placed movably for movements above the supporting table in guides in two opposite sidewalls of the supporting table, where right-angled angle bars at both sides of the supporting table guarantee a balanced lateral shift of the bridge above the supporting table and/or the sticking cylinder is at each of the ends equipped with a pressure mechanism placed at the lower bridge crossbeam and with a lifting element in the placing of the hanger of the bridge, so it is possible to move bridge bearings evenly and vertically above the working surface and/or the supporting table consists of at least one pair of tubular inner square profiles and outer square profiles with different dimensions inserted one into the other one, wherein the supporting table has at least one pre-tension element to set the height of the relevant part of the working surface of the supporting table by pressing away the upper surfaces of the inner profile and the outer profile mutually, where the pre-tension element is controlled by appropriate holes in lower surfaces of the inner profile and the outer profile and/or the guide consists of a right-angled angle bar fastened into the construction of the side wall of the supporting table for the bridge travel, which is equipped with two rolling elements and/or the cover of the side wall of the bridge is equipped with an integrated handle to move the sticking cylinder manually.

Ends of the sticking cylinder in the bridge bearing move vertically to the working surface from the manipulating position to the working position using the tensioning mechanism and from the working position to the manipulating position using lifting elements. Thanks to the preferable construction and identical pressures, both ends of the sticking cylinder move absolutely evenly. With rolling elements placed and moving in the construction of the supporting table, the bridge travels secure an absolutely accurate and smooth movement of the sticking cylinder on the working surface.

The sticking cylinder, as a part of the frame construction of the bridge, is handled by a tensioning mechanism that has its tensioning element attached to the lower crossbeam of the bridge. The hanger of the bridge beam of the sticking cylinder is placed vertically slidably in the bridge travel, where the stroke to the upper dead centre is secured with a lifting element and the adjustable pressure of the sticking cylinder is caused by the pressing mechanism with at least one linear tensioning element, which at one end has anchored two strings running over at least one tensioning pulley and guiding pulleys to each one of hangers at ends of the sticking cylinder.

Using the string mechanism guarantees an even pressure that acts on both ends of the sticking cylinder with evenly distributed force. That secures the self-adhesive large-area foil to be accurately and correctly stuck to the bottom surface in the working position. The supporting table construction contains the inner profile anchoring at sides of the supporting table anchored into the outer profile with setting blocks. The inner profile has threads in its wall that allow the pre-tension elements to be inserted and used for separating both profiles mutually in the middle. In the outer profile, there are mounting holes created that allow screws to be inserted and handled.

The construction of the side wall of the supporting table for the bridge travel with an integrated L profile is compact and lightweight, wherein its stiffness when moving the bridge above the working surface is maintained. The ergonomic cover for the lateral side of the bridge contains an integrated handle that secures easy controlling the movement of the sticking cylinder on the working surface manually.

The linear tensioning element is a rectilinear electric motor that replaces the pneumatic cylinder. Any connection to the compressed air source is not necessary, just an ordinary connection to the power distribution is sufficient. The lifting element is a gas spring with one end attached to the bridge travel and the other end attached to the hanger. The optimal pressure of the gas spring provides an immediate stroke of the sticking cylinder above the working surface into the manipulating position whenever the tensioning element stops acting in the working position.

The supporting table is equipped with hinged supports that secure keeping the lamination machine movable. The preferable configuration makes the transport, manipulation and storage of the lamination machine easier.

### BRIEF DESCRIPTION OF THE DRAWINGS

The invention is displayed in details in the attached figures—

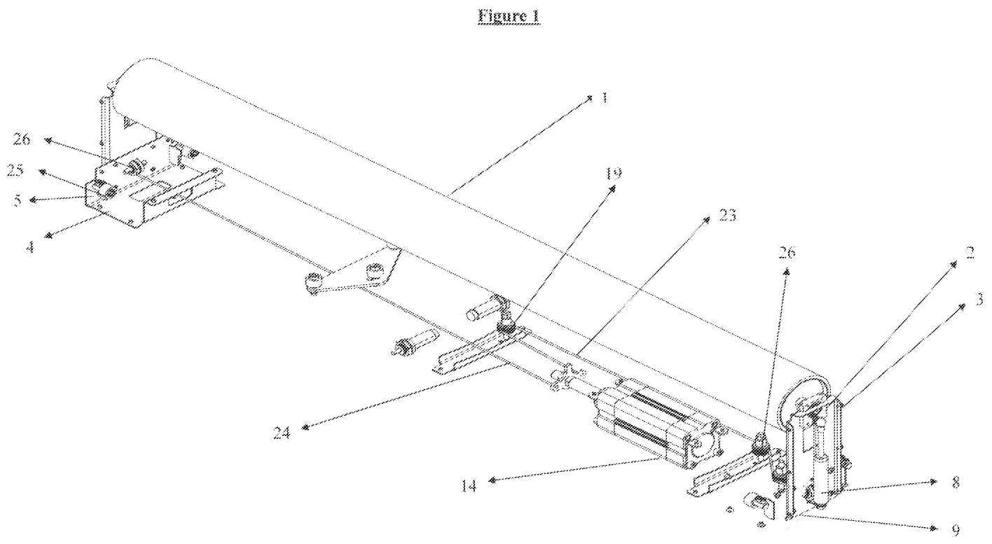

the FIG. 1 represents the functional part of the bridge,

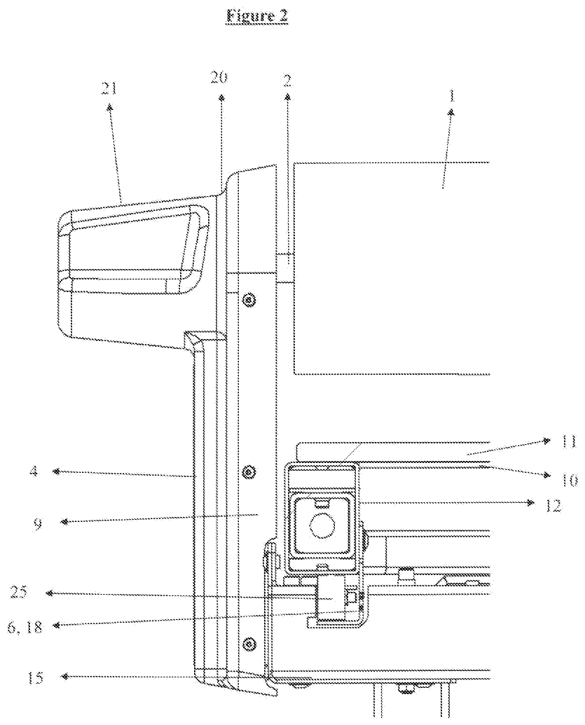

the FIG. 2 represents the lateral cover of the bridge with an integrated handle,

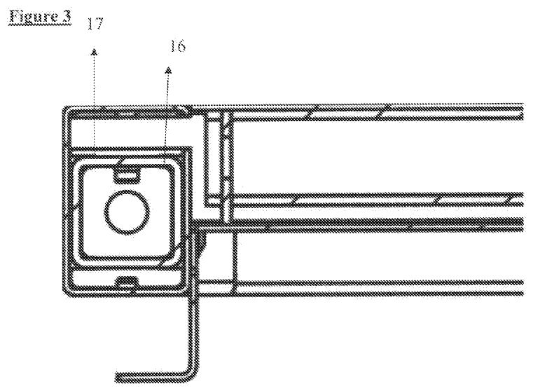

the FIG. 3 represents the section through profiles of the supporting table,

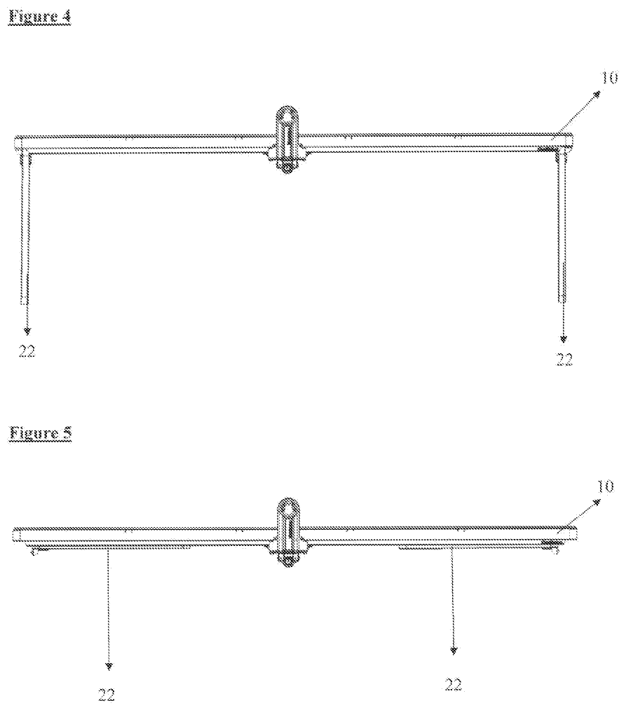

the FIG. 4 shows the lamination machine in the working position and

the FIG. 5 shows the lamination machine assembled for storage or transport.

### DETAILED DESCRIPTION OF THE INVENTION

The lamination machine with a supporting table 10 and a sticking cylinder 1, which is a part of the frame bridge 4 put on the supporting table 10, consists of the sticking cylinder 1 that is at each end 2 placed rotationally into the bearing 3 of the bridge 4, which is placed in a hanger 9 carried by two travels 5 of the bridge 4 so it is placed movably parallelly above the working surface 11 of the supporting table 10, furthermore both travels 5 of the bridge 4 ale linked by the lower crossbeam 15 of the bridge 4 and placed movably for movements above the supporting table 10 in guides 6 in two opposite sidewalls 12 of the supporting table 10, where right-angled angle bars 18 at both sides of the supporting table 10 guarantee a balanced lateral shift of the bridge 4 above the supporting table 10.

The sticking cylinder 1 is at each end 2 equipped with a pressure string mechanism 7 placed at the lower crossbeam 15 of the bridge 4 and with a lifting element 8 in the placing of the hanger 9 of the bridge 4, so it is possible to move bearings 3 of the bridge 4 evenly vertically above the working surface 11.

The supporting table 10 consists of at least one pair of tubular inner square profiles 16 and outer square profiles 17 with different dimensions inserted one into the other one, wherein the supporting table has at least one pre-tension element 13 to set the height of the relevant part of the working surface 11 of the supporting table 10 by pressing away the upper surfaces of the inner profile 16 and the outer profile 17 mutually, where the pre-tension element 13 is controlled by appropriate holes in lower surfaces of the inner profile 16 and the outer profile 17.

The guide 6 consists of a right-angled angle bar 18 fastened into the construction of the side wall 12 of the supporting table 10 for the travel 5 of the bridge 4, which is equipped with two rolling elements 25. The cover 20 for the side wall of the bridge 4 is equipped with an integrated handle 21 to move the sticking cylinder 1 manually.

The hanger 9 of the bearing 3 of the bridge 4 of the sticking cylinder 1 is placed vertically slidably in the travel 5 of the bridge 4, where the stroke to the upper dead centre is secured with a lifting element 8 and the adjustable pressure of the sticking cylinder 1 is caused by the pressing mechanism 7 with at least one linear tensioning element 14, which at one its end has anchored two strings 23, 24 running over at least one tensioning pulley 19 and guiding pulleys 26 to each one of hangers 9 at ends 2 of the sticking cylinder 1.

The linear tensioning element 14 is a rectilinear electric motor. The lifting element 8 is a gas spring with one end attached to the travel 5 of the bridge 4 and the other end attached to the hanger 9. The supporting table 10 is equipped with hinged supports 22 that secure keeping the lamination machine movable. The operator of the lamination machine puts the device into operation by presetting the hinged supports 22—legs into the working position, which is stabilized for the application by sticking the foil to the bottom board placed on the working surface 11 of the supporting table 10.

The gas springs 8 hold the sticking cylinder 1 in the manipulation (lifted) position and the operator places the self-adhesive foil on the bottom board of the product. By switching on the rectilinear electric motor 14, which is set to the tension appropriate for the product type, two strings 23, 24 tighten and press the sticking cylinder 1 against the working surface 11 with the foil and bottom plate. Subsequently the operator uses the integrated handle 21 to flatten the whole surface of the self adhesive foil with the sticking cylinder 1 and spreads it perfectly to the bottom plate. Then the operator switches off the rectilinear electric motor 14, strings 23, 24 get loose and the gas springs 8 lift the sticking cylinder 1 above the working surface 11. The operator takes the finished product out of the lamination machine and then can move on to the next sticking task.

The lamination machine provides adhering large-area and self-adhesive material to raw boards, semi-finished products or eventually already finished products by using the defined pressure between the self-adhesive material and the applied surface without optical defects or air bubbles.

1. The A lamination machine with a supporting table and a sticking cylinder, which is a part of the frame bridge that is put on the supporting table, wherein the sticking cylinder (1) is at each end (2) placed rotationally into the bearing (3) of the bridge (4), which is placed in a hanger (9) carried by at least one travel (5) of the bridge (4) so it is placed movably and parallelly above the working surface (11) of the supporting table (10), besides the travels (5) of the bridge (4) ale linked by the lower crossbeam (15) of the bridge (4) and placed movably for movements above the supporting table (10) in guides (6) in two opposite sidewalls (12) of the supporting table (10), where right-angled angle bars (18) at both sides of the supporting table (10) guarantee a balanced lateral shift of the bridge (4) above the supporting table (10) and/or the sticking cylinder (1) is at each end (2) equipped with a pressure string mechanism (7) placed at the lower crossbeam (15) of the bridge (4) and with a lifting element (8) in the placing of the hanger (9) of the bridge (4) to move bearings (3) of the bridge (4) evenly and vertically above the working surface (11) and/or the supporting table (10) consists of at least one pair of tubular inner square profiles (16) and outer square profiles (17) with different dimensions inserted one into the other one, wherein the supporting table has at least one pre-tension element (13) to set the height of the relevant part of the working surface (11) of the supporting table (10) by pressing away the upper surfaces of the inner profile (16) and the outer profile (17) mutually, where the pre-tension element (13) is controlled by appropriate holes in lower surfaces of the inner profile (16) and the outer profile (17) and/or the guide (6) consists of a right-angled angle bar (18) fastened into the construction of the side wall (12) of the supporting table (10) for the travel (5) of the bridge (4), which is equipped with two rolling elements (25) and/or the cover (20) for the side wall of the bridge (4) is equipped with an integrated handle (21) to move the sticking cylinder (1) manually.

2. The lamination machine according to the claim 1, wherein the hanger (9) of the beam (3) of the bridge (4) of the sticking cylinder (1) is placed vertically and slidably in the travel (5) of the bridge (4), where the stroke to the upper dead centre is secured with a lifting element (8) and the adjustable pressure of the sticking cylinder (1) is caused by the pressing mechanism (7) with at least one linear tensioning element (14), which at one end has anchored two strings (23, 24) running over at least one tensioning pulley (19) and guiding pulleys (26) to each one of hangers (9) at ends (2) of the sticking cylinder (1).

3. The lamination machine according to the claim 1 wherein the linear tensioning element (14) is a rectilinear electric motor.

4. The lamination machine according to the claim 1 wherein the lifting element (8) is a gas spring with one end attached to the travel (5) of the bridge (4) and the other end attached to the hanger (9).

5. The lamination machine according to the claim 1 wherein the supporting table (10) is equipped with hinged supports (22) to secure keeping the lamination machine movable.
